(19) United States
(12) Patent Application Publication
(10) Pub. No.: US 2014/0278462 A1
(43) Pub. Date: Sep. 18, 2014

(54) INFORMATION SYSTEM AND METHOD

(71) Applicants: Larry E. Jones, Longwood, FL (US); Pranam Ben, MAITLAND, FL (US)

(72) Inventors: Larry E. Jones, Longwood, FL (US); Pranam Ben, MAITLAND, FL (US)

(21) Appl. No.: 13/836,118

(22) Filed: Mar. 15, 2013

(51) Int. Cl. G06F 19/00

(52) U.S. Cl. CPC G06F 19/327
USPC 705/2

(57) ABSTRACT

An information system may include a server with a computer processor. Medical provider availability data, payment data, medical provider expertise data, patient clinical data, medical provider physical location data, patient data, and patient status data may be supplied by each of a plurality of medical providers to the server. A referral module may be accessible by a user to communicate with the plurality of medical providers and to provide from the server the medical provider availability data, payment data, medical provider expertise data, patient clinical data, medical provider physical location data, patient data, and/or patient status data to the user. A scheduling module in communication with the server may schedule any of the plurality of medical providers based upon the medical provider availability data, payment data, medical provider expertise data, patient clinical data, medical provider physical location data, patient data, and/or patient status data.

### BACKGROUND

The disclosure relates to the field of computer systems, and, more particularly, to health care management using computer systems.

Accountable Care Organizations (ACOs) may be generating an impact on the healthcare industry. The ACO model is designed to put the patient front and center, and there are multiple benefits to proactively managing a patient's total care: it is better for the patient's health, it saves money for the insurer, and the ACO providers get paid. The amount that the providers are paid depends on how well their ACO performs.

### SUMMARY

In one embodiment, an information system may include a server with a computer processor. Medical provider availability data, payment data, medical provider expertise data, patient clinical data, medical provider physical location data, patient data, verification data, and patient status data may be supplied by each of a plurality of medical providers to the server. A referral module may be accessible by a user to communicate with the plurality of medical providers and to provide from the server the medical provider availability data, payment data, medical provider expertise data, patient clinical data, medical provider physical location data, patient data, verification data, and/or patient status data to the user. A scheduling module in communication with the server may schedule any of the plurality of medical providers based upon the medical provider availability data, payment data, medical provider expertise data, patient clinical data, medical provider physical location data, patient data, verification data, and/or patient status data.

The medical provider scheduled may not be an employee of the user, a business associate of the user, and may not receive compensation from the user. The user may access the server by a physical user interface not owned by the server controller, and each of the plurality of medical providers may access the server by a physical medical provider interface not owned by the server controller.

The system may also include a messaging module that enables the user, any of the plurality of medical providers, and/or a patient to communicate through the server with each other. The system may further include a care wizard to generate a patient care plan based upon patient clinical data and input from a user resulting from a decision tree.

The care module may include scheduling, thresholds, and alerts that are generated for at least one of the user and a patient. The system may additionally include a clinical decision module that reviews patient clinical data of a plurality of patients to identify at-risk patients that are then monitored as required. The monitoring may include scheduling, thresholds, and alerts that are generated for an at-risk patient.

The server may use encryption for inbound and outbound communications regarding patient clinical data and/or patient data. The system may also include a means for education of the user, any of the plurality of medical providers, and/or a patient.

Another aspect is a method, which may include supplying by each of a plurality of medical providers to a server at least three of medical provider availability data, payment data, medical provider expertise data, patient clinical data, medical provider physical location data, patient data, verification data, and patient status data. The method may also include using a referral module to communicate between a user and the plurality of medical providers, the referral module to provide from the server the at least three of medical provider availability data, payment data, medical provider expertise data, patient clinical data, medical provider physical location data, patient data, verification data, and patient status data to the user. The method may further include scheduling any of the plurality of medical providers based upon the at least three of medical provider availability data, payment data, medical provider expertise data, patient clinical data, medical provider physical location data, patient data, verification data, and patient status data.

The method may also additionally include accessing the server by the user via a physical user interface not owned by the server controller, and each of the plurality of medical providers accesses the server by a physical medical provider interface not owned by the server controller. The method may also include communicating through a messaging module among at least two of the user, any of the plurality of medical providers, and a patient on the server with each other.

The method may further include generating a patient care plan based upon patient clinical data and input from a user resulting from a decision tree. The method may additionally include generating scheduling, thresholds, and alerts for at least one of the user and a patient based upon the patient care plan.

The method may also include generating a group care plan based upon clinical data and input from a user resulting from a decision tree. The method may further include generating scheduling, thresholds, and alerts for an at-risk patient based upon the monitoring. The method may additionally include encrypting inbound and outbound communications for the server regarding patient clinical data and patient data.

Another aspect is computer readable program codes coupled to tangible media to improve a circuit design system. The computer readable program codes may be configured to cause the program to supply by each of a plurality of medical providers to a server at least three of medical provider availability data, payment data, medical provider expertise data, patient clinical data, medical provider physical location data, patient data, verification data, and patient status data. The computer readable program codes may also use a referral module to communicate between a user and the plurality of medical providers, the referral module to provide from the server the at least three of medical provider availability data, payment data, medical provider expertise data, patient clinical data, medical provider physical location data, patient data, verification data, and patient status data to the user.

The computer readable program codes may further schedule any of the plurality of medical providers based upon the at least three of medical provider availability data, payment data, medical provider expertise data, patient clinical data, medical provider physical location data, patient data, verification data, and patient status data. The computer readable program codes may additionally generate a patient care plan based upon patient clinical data and input from a user resulting from a decision tree.

### BRIEF DESCRIPTION OF THE DRAWINGS

FIG. 1 is a block diagram illustrating an information system in accordance with various embodiments.

FIG. 2 is a flowchart illustrating method aspects according to various embodiments.

FIG. 3 is a flowchart illustrating method aspects according to the method of FIG. 2.

FIG. 4 is a flowchart illustrating method aspects according to the method of FIG. 2.

FIG. 5 is a flowchart illustrating method aspects according to the method of FIG. 2.

FIG. 6 is a flowchart illustrating method aspects according to the method of FIG. 5.

FIG. 7 is a flowchart illustrating method aspects according to the method of FIG. 2.

FIG. 8 is a flowchart illustrating method aspects according to the method of FIG. 7.

FIG. 9 is a flowchart illustrating method aspects according to the method of FIG. 2.

FIG. 10 is an alternative block diagram illustrating an information system in accordance with various embodiments.

FIG. 11 is a block diagram illustrating an information system in accordance with various embodiments.

### DETAILED DESCRIPTION

Embodiments will now be described more fully hereinafter with reference to the accompanying drawings, in which preferred embodiments are shown. Like numbers refer to like elements throughout.

With reference now to FIG. 1, an information system 10 is initially described. In an embodiment, the information system 10 includes a server 12 with a computer processor 14. Medical provider availability data, payment data, medical provider expertise data, patient clinical data, medical provider physical location data, patient data, and patient status data is supplied by each of a plurality of medical providers 16 and a patient 22 to the server 12.

Medical provider availability data comprises a selected calendar date, time, and/or the like in which a medical provider 16 such as a physician, physician assistant, nurse, physical therapist, and/or the like is available to provide treatment to a patient 22. Payment data comprises insurance information, self-payment option(s), voucher, billing information, and/or the like used to pay a medical provider 16 for services, expenses, products, and/or the like. Medical provider expertise data comprises medical provider 16 licensing information, practice specialty information, and/or the like related to the medical providers services and/or products offered. Patient clinical data comprises information regarding a patient's 22 medical history, patient's current condition(s), family medical history, and/or the like. Medical provider physical location data comprises street address, office number, telephone number, and/or the like of a selected medical provider 16. Patient data comprises contact information for a patient 22. Verification data comprises confirmation and the particulars for an appointment between a patient 22 and the user 20 and/or medical provider 16. Patient status data comprises test results, regime adherence information, and/or the like for a particular patient 22.

The system also includes a referral module 18 accessible by a user 20 to communicate with the plurality of medical providers 16 and to provide from the server 12 the medical provider availability data, payment data, medical provider expertise data, patient clinical data, medical provider physical location data, patient data, and/or patient status data to the user. The user 20 comprises a physician, physician assistant, nurse, physical therapist, medical provider office personnel, patient 22, and/or the like that use the referral module 18 to gain visibility on the current available resources that match a particular patient's needs.

The system further includes a scheduling module 24 in communication with the server 12 that schedules any of the plurality of medical providers 16 based upon the medical provider availability data, payment data, medical provider expertise data, patient clinical data, medical provider physical location data, patient data, and/or patient status data, the scheduling module outputting verification data to the patient 22 and at least one of the user 20 and one of the plurality of medical providers 16. In other words, the scheduling module 24 uses the information generated by the referral module 18 to schedule an appointment for the patient 22. In one embodiment, the scheduling module provides confirmation and/or the particulars for an appointment between a patient 22 and the user 20 and/or medical provider 16.

In one embodiment, the medical provider 16 scheduled is not be an employee of the user 20, is not a business associate of the user, and/or does not receive compensation from the user. Stated another way, the user 20 and the medical provider 16 may be affiliated, but are not business partners with each other.

In one embodiment, the user 20 accesses the server 12 by a physical user interface 26 not owned by the server controller, and each of the plurality of medical providers 16 access the server by a physical medical provider interface 28 not owned by the server controller. In other words, the server 12 is controlled by an entity different than the entity that controls the physical user interface 26 and the physical user interface 28 because system 10 is a provided service. In another embodiment, the physical user interface 26 and/or the physical user interface 28 comprise a desktop computer, smart phone, computer tablet, thin client terminal, and/or the like. In another embodiment, the term “physical” in the physical user interface 26 and/or the physical user interface 28 means a tangible object.

In one embodiment, the system 10 also includes a messaging module 30 that enables the user 20, any of the plurality of medical providers 16, and/or the patient 22 to communicate through the server 12 with each other. For example, the system 10 provides email, text messaging, tweet, and/or the like among the user 20, any of the plurality of medical providers 16, and/or the patient 22.

In one embodiment, the system 10 further includes a care wizard 32 to generate a patient care plan based upon patient clinical data and user 20 input that includes results from a decision tree. For instance, the care wizard guides a user 20 and/or medical provider 16 through a series of questions to customize a patient's 22 care plan in view of the patient clinical data, user's expertise, medical provider's expertise, and/or clinical best practices.

In another embodiment, the care wizard 32 includes scheduling, thresholds, and alerts that are generated for the user 20 and/or a patient 22. For example, the care wizard 32 produces the patient care plan and uses the scheduling module 24 to help setup appoints for the patient 22. In addition, thresholds can be set-up based upon the patient clinical data and sent through the messaging module 30 to notify the user 20, any of the plurality of medical providers 16, and/or the patient 22 of out of range test results and/or the like. The alerts can be setup for out of range test results, appointment reminders, and/or the like.

In one embodiment, the system 10 additionally includes a clinical decision module 34 that reviews patient clinical data of a plurality of patients 22 to identify at-risk patients that are then monitored as required. The monitoring may include scheduling, thresholds, and alerts that are generated for an at-risk patient.

In one embodiment, the server 12 uses encryption for inbound and outbound communications regarding patient clinical data and/or patient data. In another embodiment, the system 10 uses encryption for communication among the server 12, the user 20, any of the plurality of medical providers 16, and/or the patient 22.

In one embodiment, the system 10 also includes a means for education 36 of the user 20, any of the plurality of medical providers 16, and/or the patient 22. The means for education 36 includes audio, video, and/or the like.

In one embodiment, the system 10 includes a communications network 17, which enables a signal to travel anywhere within system 10 and/or to any other system connected to system 10. The communications network 17 is wired and/or wireless, for example. The communications network 17 is local and/or global with respect to system 10, for instance.

Another aspect is a method, which is now described with reference to flowchart 38 of FIG. 2. The method begins at Block 40 and may include supplying by each of a plurality of medical providers and a patient to a server at least three of medical provider availability data, payment data, medical provider expertise data, patient clinical data, medical provider physical location data, patient data, and patient status data at Block 42. The method may also include using a referral module to communicate between a user and the plurality of medical providers, the referral module to provide from the server the at least three of medical provider availability data, payment data, medical provider expertise data, patient clinical data, medical provider physical location data, patient data, and patient status data to the user at Block 44. The method may further include scheduling any of the plurality of medical providers based upon the at least three of medical provider availability data, payment data, medical provider expertise data, patient clinical data, medical provider physical location data, patient data, and patient status data, the scheduling module outputting verification data to the patient and at least one of the user and one of the plurality of medical providers at Block 46. The method ends at Block 48.

In another method embodiment, which is now described with reference to flowchart 50 of FIG. 3, the method begins at Block 52. The method may include the steps of FIG. 2 at Blocks 42, 44, and 46. The method may additionally include accessing the server by the user via a physical user interface not owned by the server controller, and each of the plurality of medical providers accesses the server by a physical medical provider interface not owned by the server controller at Block 54. The method ends at Block 56.

In another method embodiment, which is now described with reference to flowchart 58 of FIG. 4, the method begins at Block 60. The method may include the steps of FIG. 2 at Blocks 42, 44, and 46. The method may additionally include communicating through a messaging module among at least two of the user, any of the plurality of medical providers, and a patient on the server with each other at Block 62. The method ends at Block 64.

In another method embodiment, which is now described with reference to flowchart 66 of FIG. 5, the method begins at Block 68. The method may include the steps of FIG. 2 at Blocks 42, 44, and 46. The method may additionally include generating a patient care plan based upon patient clinical data and input from a user resulting from a decision tree at Block 70. The method ends at Block 72.

In another method embodiment, which is now described with reference to flowchart 74 of FIG. 6, the method begins at Block 76. The method may include the steps of FIG. 5 at Blocks 42, 44, 46, and 70. The method may additionally include generating scheduling, thresholds, and alerts for at least one of the user and a patient based upon the patient care plan at Block 78. The method ends at Block 80.

In another method embodiment, which is now described with reference to flowchart 82 of FIG. 7, the method begins at Block 84. The method may include the steps of FIG. 2 at Blocks 42, 44, and 46. The method may additionally include generating a group care plan based upon clinical data and input from a user resulting from a decision tree at Block 86. The method ends at Block 88.

In another method embodiment, which is now described with reference to flowchart 90 of FIG. 8, the method begins at Block 92. The method may include the steps of FIG. 7 at Blocks 42, 44, 46, and 86. The method may additionally include generating scheduling, thresholds, and alerts for an at-risk patient based upon the monitoring at Block 94. The method ends at Block 96.

In another method embodiment, which is now described with reference to flowchart 98 of FIG. 9, the method begins at Block 100. The method may include the steps of FIG. 2 at Blocks 42, 44, and 46. The method may additionally include encrypting inbound and outbound communications for the server regarding patient clinical data and patient data at Block 102. The method ends at Block 104.

Another aspect is computer readable program codes coupled to tangible media for an information system 10. The computer readable program codes may be configured to cause the program to supply by each of a plurality of medical providers 16 and a patient 22 medical provider availability data, payment data, medical provider expertise data, patient clinical data, medical provider physical location data, patient data, and/or patient status data to a server 12. The computer readable program codes may also use a referral module 18 to communicate between a user 20 and the plurality of medical providers 16, the referral module to provide from the server 12 the medical provider availability data, payment data, medical provider expertise data, patient clinical data, medical provider physical location data, patient data, and/or patient status data to the user.

The computer readable program codes may further schedule any of the plurality of medical providers 16 based upon the medical provider availability data, payment data, medical provider expertise data, patient clinical data, medical provider physical location data, patient data, and/or patient status data, the scheduling module outputting verification data to the patient 22 and at least one of the user 20 and one of the plurality of medical providers 16. The computer readable program codes may additionally generate a patient care plan based upon patient clinical data and input from the user 20 resulting from a decision tree.

In view of the foregoing, system 10 provides a medical information system that enables provider access, collaboration, and interactions. System 10 provides easy, secure and real time access to data for providers and patients alike. Users of the system 10 are able to see the value in both savings and overall process improvement.

For example, system 10 provides overcomes interface and interoperability issues, and security and privacy controls are comprehensive. System 10 also enables the tracking of clinical and operational outcomes.

System 10, e.g. HPFConnect, is built as an operational tool that will enable all users—providers, patients, care managers and administrators to benefit from the various features on a day to day operational basis. The database and analytics are engrained into operational workflows that provide increased value and better access to patient data. The platform is also mobile enabled that makes it easier for users to access while they are on the go.

In one embodiment, system 10 is a Health Information Exchange (HIE) and Accountable Care Organization (ACO) platform that addresses growing healthcare needs, while improving both patient satisfaction and organizational efficiencies. The platform of system 10 also serves as a HIPAA-compliant tool for secure data exchange that improves cost and efficiency for both hospitals and physicians.

In one embodiment, system 10 is an online repository for patient information that promotes a collaborative framework for all providers. The solution is a combination of efficient tools, resulting in a one stop content management system.

The operational nature of system 10 overcomes the fundamental issue of user adoption and day to day benefits of the prior approaches. There are specific apps within the platform that cater to day to day needs such as Referrals 18, Messaging 30, provider look ups, scheduling 24, discharge notes, care plans, care interventions, and/or the like.

In one embodiment, system 10 is a state of the art health information exchange (HIE) and ACO platform. Interoperability is the key to enhanced performance and cost reduction in patient care and treatment. System 10 will provide a secure data exchange platform for physicians, patients and other health care providers.

In one embodiment, Providers and physicians using system 10 can electronically receive and manage referrals, exchange patient clinical information, arrange the right care for patients, increase affiliations and revenue, improve physician satisfaction and loyalty, collaborate in real time, market services, and manage informative content online.

In one embodiment, system 10 does not require purchase of additional software or hardware. There are no implementation fees, no time for install and more importantly the system users do not need to worry about maintenance issues because the system has been built using the SaaS (Software as a Service) model.

Making referrals for specialty or follow-up care is typically a fairly manual process—the originating physician may make a phone call or fax a request to a specialist, but in most cases that's as technologically advanced as it gets. Most likely, the patient will receive a slip of paper and instructions to make an appointment for follow-up care. In essence, all participants must rely on paper, telephone calls and faxes for communication and coordination. The result is a bottle-necked process that doesn't allow the referrer and the receiver to track the status and follow-up on care. The patient is disillusioned because they may or may not have an existing relationship with potential care sites and a lack of proper information does not help. Physicians and other clinicians who refer patients are well aware that some of the referrals may be denied or put on hold for various reasons but they do not have any visibility. The resulting gaps are extremely frustrating for everyone involved, plus there can be serious consequences—particularly when urgent follow-up is needed and costs increase because patients are forced to seek care in emergency rooms.

In one embodiment, system 10 uses web-based technology to not only automate the referral process but to also usher in flexibility, enhance tracking and bridge the communication gap between the primary care physicians and the hospitals. For patients, system 10 will enable a process that can match them with a specific provider that not only has the right capacity to provide adequate care but is also willing to accept their insurance or self-pay status. The model is to have physician offices and providers come to a centralized web location, e.g. server 12, and have an orderly, reliable, flexible, quick, easy and successful referral process.

With additional reference to FIGS. 10 and 11, in one embodiment, system 10 includes Referrals and Scheduling, Secure Messaging, Referral and Messaging reports, Provider look up and Interfaces, HL7 and CCD interfaces, Appointment reminders and notifications, Health Risks Assessment, Risk stratification and reports, Real time eligibility verification, Patient clinical health profile, Care Plan Wizard, Clinical Analytics, Care Interventions, Clinical command center dashboard, Provider Education, Program and Network management, Clinical Decision Support System, and Patient Education.

In one embodiment, system 10 includes system inbox with secure, reliable and real-time messaging to exchange referral and patient information with providers. In another embodiment, system 10 includes schedule module 24, which is an efficient, flexible and reliable way to refer patients to a provider of choice with real-time verification.

In one embodiment, system 10 includes search tools that enable search for providers based on criteria such as patient preference, condition, services, proximity, and/or insurance plans accepted, plus search ICD-10 and CPT codes for services and diagnostic procedures. In another embodiment, system 10 includes referral module 18 to send, receive and process referrals between different providers.

In one embodiment, system 10 includes care management, which is a preventive care management program that allows for stratification of patient data and a proactive focus on at-risk patients. In another embodiment, system 10 includes patient health profile, e.g. patient clinical data, which is a comprehensive patient health profile comprised of demographics, health risk assessment, clinical documents, and medical histories.

In one embodiment, system 10 includes data analytics that track and report on patient data against federal standards for seamless transitions and improved continuity of care. In another embodiment, system 10 includes contact solution support to provide feedback, contact customer service and review account information.

In one embodiment, system 10 includes a system inbox that provides secure, reliable and real-time messaging to exchange referral and patient information with providers. In another embodiment, system 10 includes schedule module 24 that provides efficient, flexible and reliable way to refer patients to a provider of choice with eligibility approval beforehand.

In one embodiment, system 10 includes look up that provides ICD-10 and CPT codes, real time for services and diagnostic procedures. In another embodiment, system 10 includes a referral manager that provides real-time queue of referral requests as received by time of day to enable easy and fast response from provider.

In one embodiment, system 10 includes clinical decision module 34, which is a preventive care management program that allows for stratification of patient data and a proactive focus on at-risk patients. In another embodiment, system 10 includes monitoring & reporting to track the patient against federal standards for seamless transitions and improved continuity of care.

In one embodiment, system 10 enables at-risk patients to be stratified and proactively monitored while diverse patient populations can be tracked with real-time reporting. In another embodiment, system 10 offers the ability to market services and specials online so providers can reach a broad audience.

In one embodiment, system 10 enables providers to electronically receive and manage referrals, exchange patient clinical information, increase affiliations and patient revenue, improve physician satisfaction and loyalty, collaborate with physicians in real time, market services and manage informative content (including media) online. In another embodiment, system 10 can be accessed from mobile devices.

In one embodiment, system 10 houses HL7, CCD and XML-based interfaces for real time data exchange. In another embodiment, system 10 includes enterprise-grade security that offers reliability and performance.

In one embodiment, system 10 includes components that communicate with external systems, typically to receive demographics and clinical information in the inbound interface and send demographic updates, updated clinical information and charges at the outbound interface. In another embodiment, system 10 is capable of processing bi-directional HL7 messages, CCR messages, structured messages such as XML, or even a basic ASCII file.

In one embodiment, while there are numerous ways as to how the inbound messages are typically processed—the preferred way for communication with system 10 is by invoking a web-service. In another embodiment, system 10 web services layer enables the caller application can query, retrieve and update patient information.

In one embodiment, the system's 10 improved manageability means IT teams do not have to focus on licensing, updates, performance, HIPAA compliance and availability. In another embodiment, the system's 10 flexibility and scalability means the IT team does not need to worry about building out the network and staff to handle increased transaction volumes.

In one embodiment, system 10 provides reduced bandwidth requirements and improved network performance because of the security model. In other words, offloading the security takes a lot of pressure off the enterprise to handle the incoming referral traffic, and continued benefits are realized from needing less storage and bandwidth, less management overheads and maintenance staff. In another embodiment, system 10 includes real-time reporting.

Patient care plans are a highly important but extremely cumbersome part of patient care. Currently, there are no tools that personally interact with a user in specifying specific steps which are needed to generate a complete and useful patient care plan. Nor are there any tools that allow for electronic reminders for patient interactions and/or goals, along with ease of use access tools to add, edit, and delete actions within the care plan, tracking the date, time, and user.

In one embodiment, system 10 solves the foregoing deficiency with the care wizard 32, which from the selection of the conditions, problems related to the condition will populate, asking the user to select one or multiple, and/or create new. Once the problem statement(s) are selected, associated goals will populate, asking the user to select one or multiple, and/or create new. After each goal is selected, the user will be asked to select one or multiple associated interventions. If multiple problems are selected the process will be completed one at a time.

For example, assume Patient A has a condition of COPD, and 4 problems were selected. In one embodiment, the care wizard 32 will store the problems selected and allow the user to complete the process for only 1 problem statement at a time until all 4 problems have addressed associated goals and interventions. As each section is completed care wizard 32 will auto-fill the patient care plan. The completed care plan will populate on a separate management screen that will allows the resource to add/edit/delete existing sections of the care plan, as well as add care progress notes following patient interactions. Each step will contain properties such as date, time, and user, stored in the database for audit purposes.

The care wizard 32 provides an interactive tool that allows the care plan to be completed in a step by step format. It is pre-populated, easy to use, and interactive, allowing for a personalized experience, enhancing the care resource and patient interaction. The care wizard 32 allows for easy management of the patient care plan following creation, by allowing the user to easily access relevant sections needed to add care progress notes, and/or edit existing goals and interventions. The care wizard 32 provides time/date/user stamp to all actions within the system for audit purposes, as well as for a streamlined transition of care.

As will be appreciated by one skilled in the art, aspects may be embodied as a system, method, and/or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments are described above with reference to flowchart illustrations and/or block diagrams of methods, apparatus (systems) and computer program products according to the embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated.

While the preferred embodiment has been described, it will be understood that those skilled in the art, both now and in the future, may make various improvements and enhancements which fall within the scope of the claims which follow. These claims should be construed to maintain the proper protection for the embodiments first described.

What is claimed is:

1. A system comprising:
a server including a computer processor;
at least three of medical provider availability data, payment data, medical provider expertise data, patient clinical data, medical provider physical location data, patient data, and patient status data supplied by each of a plurality of medical providers and a patient to the server;
a referral module accessible by a user to communicate with the plurality of medical providers and to provide from the server the at least three of medical provider availability data, payment data, medical provider expertise data, patient clinical data, medical provider physical location data, patient data, and patient status data to the user; and
a scheduling module in communication with the server to schedule any of the plurality of medical providers based upon the at least three of medical provider availability data, payment data, medical provider expertise data, patient clinical data, medical provider physical location data, patient data, and patient status data, the scheduling module outputting verification data to the patient and at least one of the user and one of the plurality of medical providers.

2. The system of claim 1 wherein the medical provider scheduled is not an employee of the user and does not receive compensation from the user.

3. The system of claim 1 wherein the user accesses the server by a physical user interface not owned by the server controller, and each of the plurality of medical providers accesses the server by a physical medical provider interface not owned by the server controller.

4. The system of claim 1 further comprising a messaging module that enables at least two of the user, any of the plurality of medical providers, and the patient to communicate through the server with each other.

5. The system of claim 1 further comprising a care wizard to generate a patient care plan based upon patient clinical data and user input including results from a decision tree.

6. The system of claim 5 wherein the care wizard includes scheduling, thresholds, and alerts that are generated for at least one of the user and the patient.

7. The system of claim 1 further comprising a clinical decision module that reviews patient clinical data of a plurality of patients to identify at-risk patients that are then monitored as required.

8. The system of claim 7 wherein the monitoring includes scheduling, thresholds, and alerts that are generated for an at-risk patient.

9. The system of claim 1 wherein the server uses encryption for inbound communications and outbound communications regarding patient clinical data and patient data.

10. The system of claim 1 further comprising a means for education of at least one of the user, any of the plurality of medical providers, and the patient.

11. A method comprising:
supplying to a server by each of a plurality of medical providers and a patient at least three of medical provider availability data, payment data, medical provider expertise data, patient clinical data, medical provider physical location data, patient data, and patient status data;
using a referral module to communicate between a user and the plurality of medical providers, the referral module to provide from the server the at least three of medical provider availability data, payment data, medical provider expertise data, patient clinical data, medical provider physical location data, patient data, and patient status data to the user; and
scheduling any of the plurality of medical providers based upon the at least three of medical provider availability data, payment data, medical provider expertise data, patient clinical data, medical provider physical location data, patient data, and patient status data, and the scheduling module outputting verification data to the patient and at least one of the user and one of the plurality of medical providers.

12. The method of claim 11 accessing the server by the user via a physical user interface not owned by the server controller, and each of the plurality of medical providers accesses the server by a physical medical provider interface not owned by the server controller.

13. The method of claim 11 further comprising communicating through a messaging module among at least two of the user, any of the plurality of medical providers, and the patient on the server with each other.

14. The method of claim 11 further comprising generating a patient care plan based upon patient clinical data and user input including results from a decision tree.

15. The method of claim 14 further comprising generating scheduling, thresholds, and alerts for at least one of the user and the patient based upon the patient care plan.

16. The method of claim 11 further comprising generating a group care plan based upon clinical data and input from a user resulting from a decision tree.

17. The method of claim 16 further comprising generating scheduling, thresholds, and alerts for an at-risk patient based upon the monitoring.

18. The method of claim 11 further comprising encrypting inbound and outbound communications for the server regarding patient clinical data and patient data.

19. A computer program product embodied in a tangible media comprising:
computer readable program codes coupled to the tangible media to improve a circuit's design, the computer readable program codes configured to cause the program to:
supply by each of a plurality of medical providers and a patient at least three of medical provider availability data, payment data, medical provider expertise data, patient clinical data, medical provider physical location data, patient data, and patient status data to a server;
use a referral module to communicate between a user and the plurality of medical providers, the referral module to provide from the server the at least three of medical provider availability data, payment data, medical provider expertise data, patient clinical data, medical provider physical location data, patient data, and patient status data to the user; and
schedule any of the plurality of medical providers based upon the at least three of medical provider availability data, payment data, medical provider expertise data, patient clinical data, medical provider physical location data, patient data, and patient status data, the scheduling module also outputting verification data to the patient and at least one of the user and one of the plurality of medical providers.

20. The computer program product of claim 19 further comprising program code configured to: generate a patient care plan based upon patient clinical data and user input including results from a decision tree.
